(19) United States
(12) Patent Application Publication
(10) Pub. No.: US 2004/0001250 A1
(43) Pub. Date: Jan. 1, 2004

(54) Data presentation apparatus

(76) Inventors: Tatsuru Kobayashi, Yokosuka-shi (JP); Keiichi Maeno, Tokyo (JP); Manabu Kobayashi, Saitama-shi (JP); Yoshinori Suzuki, Tokyo (JP)

Correspondence Address: NATH & ASSOCIATES, 1030 15th STREET, 6TH FLOOR, WASHINGTON, DC, 20005, US

(21) Appl. No.: 10/602,124

(22) Filed: Jun. 24, 2003

(30) Foreign Application Priority Data
Jun. 28, 2002 (JP) P2002-190481

(51) Int. Cl. G02B 1/00

(52) U.S. Cl. 359/362

(57) ABSTRACT

There is disclosed a data presentation apparatus including: a data laying table on which data such as a written/drawn draft and solid material are to be laid; an aspheric reflection mirror, disposed above the vicinity of a side part of the data laying table, for obliquely taking an image light of the data laid on the data laying table and reflecting the image light of the data; an image forming optical system which cooperates with the aspheric reflection mirror to form the image light of the data reflected by the aspheric reflection mirror into an image; and an image pickup element for receiving the image light of the data formed into the image by the image forming optical system.

### BACKGROUND OF THE INVENTION

1. Field of the Invention

The present invention relates to a data presentation apparatus in which an aspheric reflection mirror is disposed above the vicinity of a side part of a data laying table, and an image light of data laid on the data laying table is obliquely taken into the aspheric reflection mirror and reflected on an image forming optical system side. The aspheric reflection mirror cooperates with the image forming optical system to clearly form an image light of data into an image without any defocus or trapezium distortion so that an image pickup element receives the light.

2. Description of the Related Art

As an audio-visual apparatus for use in conferences and lectures, a data presentation apparatus has heretofore frequently been used in which data such as a written/drawn draft and solid material are laid on the data laying table, the data is irradiated with a lighting light emitted from a lighting apparatus, and the data is photographed by a video camera disposed above. An image of the photographed data is displayed in a monitor television set, or projected, enlarged, and displayed in a screen.

Characteristics of this type of data presentation apparatus are that a user can directly add/alter the written/drawn draft to make the presentation of the data. The apparatus is convenient as compared with a scanner by which the written/drawn draft image is taken. Some structure modes of a related-art data presentation apparatus will be described hereinafter.

FIG. 1 is a perspective view showing a data presentation apparatus according to a first example of the related art. FIG. 2 is a side view showing the data presentation apparatus according to a second example of the related art.

First, in a data presentation apparatus 100 according to the first example of the related art shown in FIG. 1, a data laying table 101 is formed in a thin box shape. A data laying surface 101a which is an upper surface of the data laying table 101 is formed to be flat. Moreover, data 102 such as the written/drawn draft and solid material can be laid on the data laying surface 101a of the data laying table 101. A first arm 103 is attached to a rear end of the data laying surface 101a so as to be rotatable in a vertical direction (arrow direction), and a video camera 104 is attached to an upper end of the first arm 103 so as to be rotatable in an arrow direction. Furthermore, at a photographing time, the first arm 103 is raised upwards, and the data 102 laid on the data laying surface 101a is photographed by the video camera 104. On the other hand, at a non-use time, the first arm 103 is moved downwards, and the video camera 104 is folded on the data laying surface 101a.

Moreover, one pair of second arms 105, 105 are attached to rear left and right ends of the data laying surface 101a. Furthermore, one pair of lighting fixtures 106, 106 are attached to the upper ends of one pair of second arms 105, 105 so as to face the data laying surface 101a.

Furthermore, an operation panel portion 107 in which operation buttons and liquid crystal panel are arranged is disposed in a front portion of the data laying table 101. In the data laying table 101, an image processing portion 108 is disposed to process the image photographed by the video camera 104 into signals and to send a video output to a monitor television set or projector (not shown).

Therefore, according to the data presentation apparatus 100 of the first example of the related art constituted as described above, since the data 102 laid on the data laying surface 101a can directly be taken into the video camera 104, the constitution of the apparatus 100 is simplified.

Next, in a data presentation apparatus 200 of the second example of the related art shown in FIG. 2, a support 202 is disposed to uprise in a rear part on a data laying table 201, and an arm 203 is extended forwards from the upper end of the support 202 along the data laying table 201. A data laying surface 201a is formed in a flat plane in the upper surface of the data laying table 201. Above data 204 such as a written/drawn draft and solid material laid on the data laying surface 201a, a first reflection mirror 205 is attached in the arm 203 disposed above the data laying surface 201a. A second reflection mirror 206 and video camera 207 are disposed in a lower part of the data laying table 201.

Therefore, according to the data presentation apparatus 200 of the second example of the related art constituted as described above, the image light of the data 204 is reflected by the first and second reflection mirrors 205, 206, and taken into the video camera 207 disposed substantially horizontally in the lower part of the data laying table 201. Therefore, while a height of the apparatus 200 is suppressed, a light path extending to the video camera 207 from the data 204 can be set to be long, and the apparatus 200 can be prevented from being enlarged.

Additionally, in the data presentation apparatus 100 of the first example of the related art shown in FIG. 1, as described above, the data 102 laid on the data laying surface 101a of the data laying table 101 can directly be taken into the video camera 104. Therefore, the constitution of the apparatus 100 is simplified. However, in order to effectively form the data 102 such as the written/drawn draft and solid material into the image on an image pickup element (not shown) disposed in the video camera 104 without being wasted, the video camera 104 needs to be disposed at a predetermined interval above the data 102 laid on the data laying surface 101a. Additionally, a light axis of the video camera 104 needs to be set substantially vertically to the data laying surface 101a and data 102.

In this case, in general, for a video camera position, with the use of a photographing lens having a short focal distance, when an angle of field increases with respect to the data 102, the video camera 104 can be disposed closer to the data 102, but the image has a large distortion.

On the other hand, with the use of the photographing lens having a long focal distance, when the angle of field to the data 102 is small, the video camera 104 can sufficiently be detached from the data 102, and the distortion becomes small, but a subject field depth of the video camera 104 becomes shallow. Especially it is difficult to focus all irregularities of the solid material. Therefore, for the height position of the video camera 104, an intermediate position is taken between positions where the angles of field are large and small. The video camera is disposed at a predetermined distance from the data laying surface 101a, but the height position of the video camera 104 at this time is in a position where a field of vision in front of the user is obstructed. The video camera 104 becomes an obstacle, a height dimension of the data presentation apparatus 100 naturally increases, and the apparatus is enlarged.

Next, in the data presentation apparatus 200 of the second example of the related art shown in FIG. 2, the image light of the data 204 laid on the data laying surface 201a of the data laying table 201 is reflected by the first reflection mirror 205 disposed above the data laying table 201 and the second reflection mirror 206 disposed under the data laying surface 201a in order, and taken into the video camera 207 disposed in the data laying table 201. In this case, when the video camera 207 is disposed substantially horizontally in the lower part of the data laying table 201, the apparatus 200 is miniaturized. Even in this case, the first reflection mirror 205 disposed above the data laying table 201 substantially blocks user's vision, and visibility of the data 204 laid on the data laying surface 201a is largely impaired.

### SUMMARY OF THE INVENTION

To solve the problem, there has been a demand for a data presentation apparatus in which a reflection mirror is disposed above a data laying table without obstructing user's vision, and even in this case an image light of data laid on the data laying table can satisfactorily be formed into an image.

To achieve the object, there is provided a data presentation apparatus comprising: a data laying table on which data such as a written/drawn draft and solid material are to be laid; an aspheric reflection mirror, disposed above the vicinity of a side part of the data laying table, for obliquely taking an image light of the data laid on the data laying table and reflecting the image light of the data; an image forming optical system which cooperates with the aspheric reflection mirror to form the image light of the data reflected by the aspheric reflection mirror into an image; and an image pickup element for receiving the image light of the data formed into the image by the image forming optical system.

In the present invention, there are disposed: the data laying table for laying the data such as the written/drawn draft and solid material; the aspheric reflection mirror, disposed on the upper part in the vicinity of the side part of the data laying table, for obliquely taking the image light of the data laid on the data laying table and reflecting the image light of the data; the image forming optical system which cooperates with the aspheric reflection mirror to form the image light of the data reflected by the aspheric reflection mirror into the image; and the image pickup element for receiving the image light of the data formed into the image by the image forming optical system. Therefore, the written/drawn draft can easily be laid on the data laying table, and user's vision is not obstructed by the aspheric reflection mirror. There can be provided a convenient data presentation apparatus. Additionally, while the image light of the data is not out of focus, the image light can optically clearly be received by the image pickup element without any trapezium distortion. Furthermore, the aspheric reflection mirror is disposed in the upper part in the vicinity of the side part of the data laying table, and the image light of the data reflected by the aspheric reflection mirror is formed into the image by the image forming optical system disposed substantially horizontally via a plane reflection mirror for changing a light path. In this case, the data presentation apparatus can be miniaturized.

In a preferred embodiment of the present invention, a variable-power optical system for optically varying magnification of the image light of the data formed into the image by the image forming optical system is further disposed between the image forming optical system and the image pickup element.

According to the embodiment, the variable-power optical system for optically varying the magnification of the image light of the data formed into the image by the image forming optical system is further disposed between the image forming optical system and the image pickup element. Therefore, the magnification of the image light of the data can clearly and optically be varied.

In another preferred embodiment of the present invention, the variable-power optical system is disposed so as to be movable in a plane crossing at right angles to a light axis of the image forming optical system.

According to the embodiment, since the variable-power optical system is disposed so as to be movable in the plane crossing at right angles to the light axis of the image forming optical system, the image light of the data in a desired range can be varied at a desired optical magnification.

In further preferred embodiment of the present invention, an electronic zoom processing device for electronically varying the magnification of the image light of the data formed into the image by the image forming optical system is further disposed.

According to the embodiment, since the electronic zoom processing device for electronically varying the magnification of the image light of the data formed into the image by the image forming optical system is further disposed, the magnification of the image light of the data can electronically be varied.

In still another preferred embodiment of the present invention, a variable-power optical system for switching the image light of the data formed into the image by the image forming optical system to a wide side or tele-side to optically vary the magnification is further disposed between the image forming optical system and the image pickup element. An electronic zoom processing device is further disposed for electronically varying the magnification of the image light of the data formed into the image by the image forming optical system between the wide side and the tele-side.

According to the embodiment, the variable-power optical system for switching the image light of the data formed into the image by the image forming optical system to the wide side or tele-side to optically vary the magnification is further disposed between the image forming optical system and the image pickup element. Additionally, the electronic zoom processing device is further disposed for electronically varying the magnification of the image light of the data formed into the image by the image forming optical system between the wide side and the tele-side. Therefore, since the variable-power optical system can optically vary the magnification only with respect to two focal distances on the wide side and the tele-side, the lens constitution of the variable-power optical system can be simplified. Moreover, electronic zoom processing can complementally be performed between the wide side and the tele-side.

In still further preferred embodiment of the present invention, a plurality of image pickup elements including light receiving regions having different sizes are prepared, and light path branch device for branching a light path toward the plurality of image pickup elements is further disposed after the image forming optical system or the variable-power optical system.

According to the embodiment, the plurality of image pickup elements different in the size of the light receiving region are prepared, and the light path branch device for branching the light path toward the plurality of image pickup elements is further disposed after the image forming optical system or after the variable-power optical system. Therefore, the image light of the data formed into the image by the image forming optical system or the variable-power optical system can be received by the image pickup element in accordance with the size of the light receiving region.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a perspective view showing a data presentation apparatus according to a first example of a related art;

FIG. 2 is a side view showing the data presentation apparatus according to a second example of the related art;

FIG. 3 is a perspective view showing an outer shape of the data presentation apparatus according to the present invention;

FIGS. 4A to 4C are a rear view, plan view, and right side view showing the data presentation apparatus according to the present invention;

FIG. 5 is a perspective view showing an inner structure from which a housing is removed in the data presentation apparatus according to the present invention;

FIG. 6 is a perspective view showing an aspheric reflection mirror, plane reflection mirror, image forming optical system, variable-power optical system, and image pickup element in the data presentation apparatus according to the present invention;

FIG. 7 is a partly cut perspective view showing the aspheric reflection mirror, plane reflection mirror, image forming optical system, variable-power optical system, and image pickup element in the data presentation apparatus according to the present invention;

FIG. 8 is a diagram schematically showing an operation of obliquely taking an image light of a written/drawn draft into the aspheric reflection mirror to reflect the light on an image forming optical system side in the data presentation apparatus according to the present invention;

FIG. 9 is an explanatory view schematically showing astigmatism by the aspheric reflection mirror and image forming optical system shown in FIG. 8;

FIG. 10 is a perspective view showing the variable-power optical system in the data presentation apparatus according to the present invention;

FIG. 11 is a diagram schematically showing that the image light of the written/drawn draft reflected by the aspheric reflection mirror is directly guided into the image forming optical system in the data presentation apparatus of a first modification example according to the present invention;

FIG. 12 is a diagram schematically showing that the variable-power optical system is disposed between the image forming optical system and image pickup element in the data presentation apparatus of a second modification example according to the present invention;

FIG. 13 is a block diagram showing an optical zoom process for optically varying magnification of an image of data formed by the image forming optical system and an electronic zoom process for electronically varying the magnification in the data presentation apparatus of the second modification example of the present invention in which the variable-power optical system is disposed between the image forming optical system and image pickup element;

FIG. 14 is a schematic diagram showing an optical zoom process for switching the image of the data formed by the image forming optical system on a wide side and tele-side to optically vary the magnification, and an electronic zoom process for electronically varying the magnification of the image of the data formed by the image forming optical system between the wide side and tele-side in the data presentation apparatus of the second modification example according to the present invention;

FIG. 15 is a diagram schematically showing that light path branch means for branching a light path toward two image pickup elements is disposed after the image forming optical system in the data presentation apparatus of a third modification example according to the present invention; and

FIGS. 16A to 16C are diagrams showing the images whose lights are received by two image pickup elements having different sizes of light receiving regions, when the light path is branched by the light path branch means shown in FIG. 15 in the data presentation apparatus of the third modification example according to the present invention.

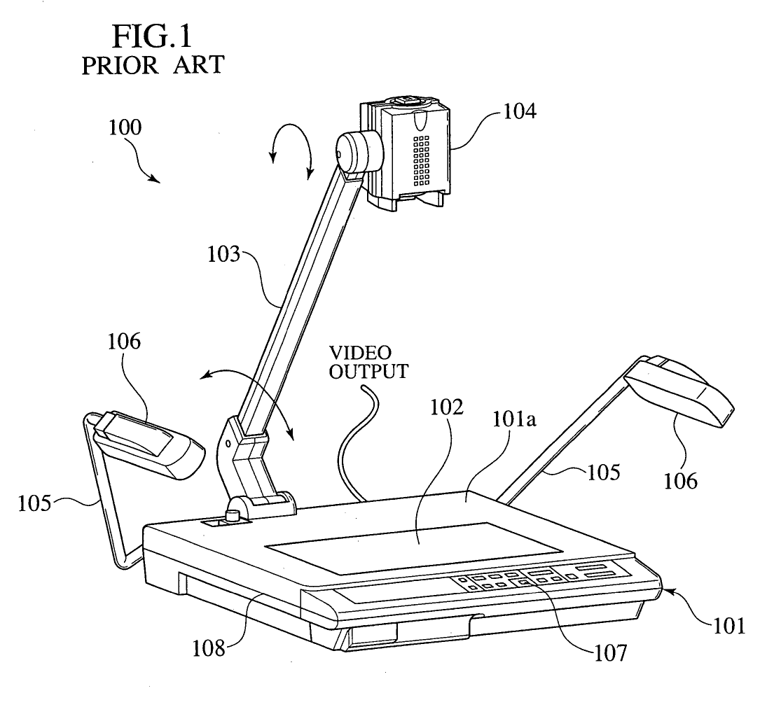

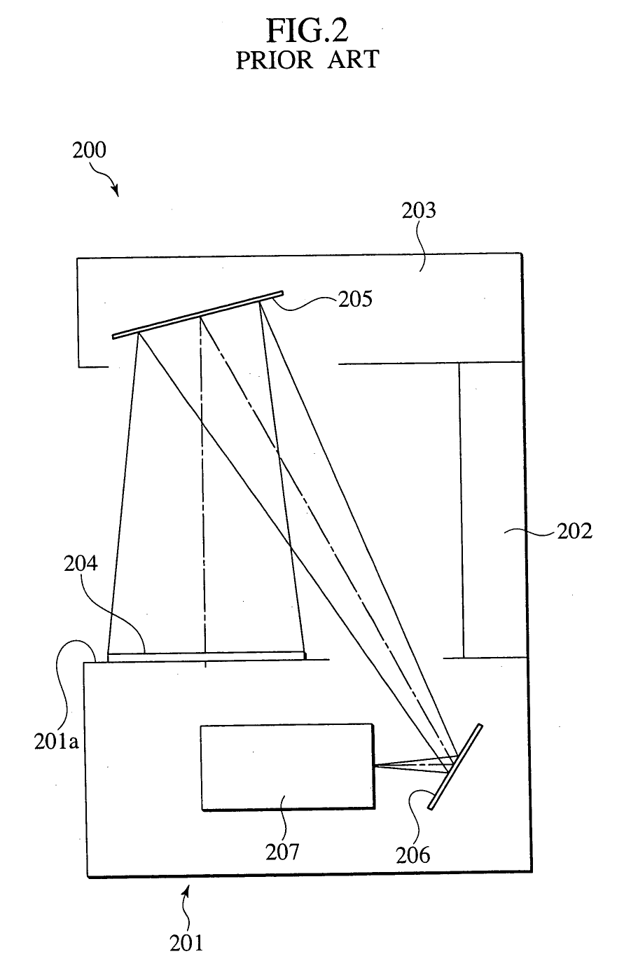

### DESCRIPTION OF THE PREFERRED EMBODIMENTS

One embodiment of a data presentation apparatus according to the present invention will be described hereinafter with reference to FIGS. 3 to 16.

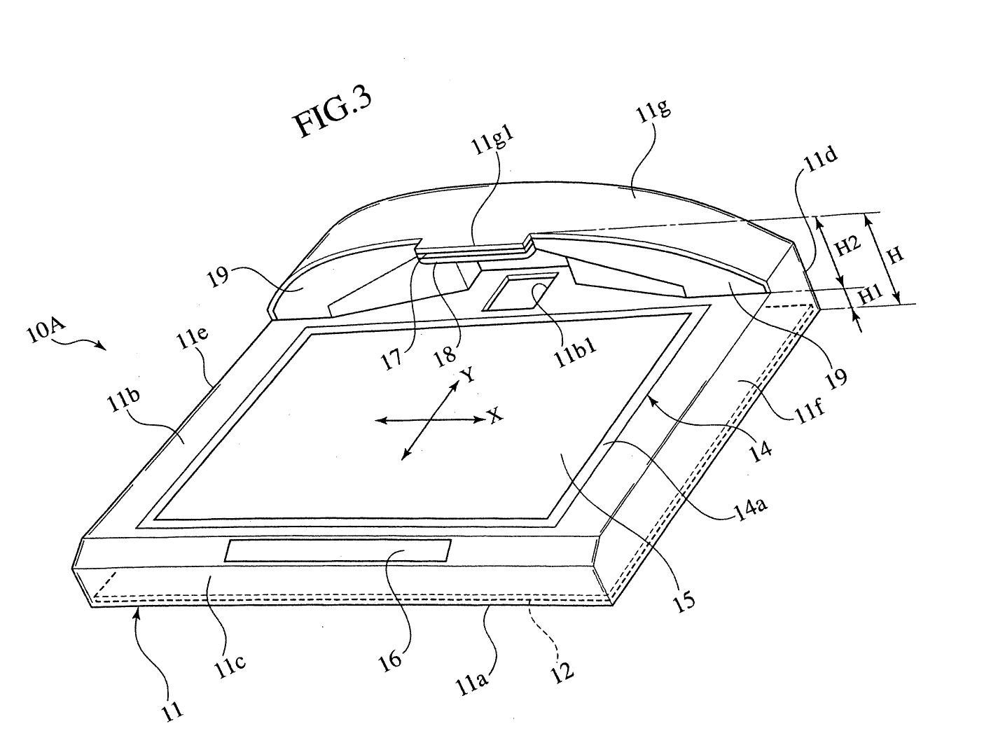

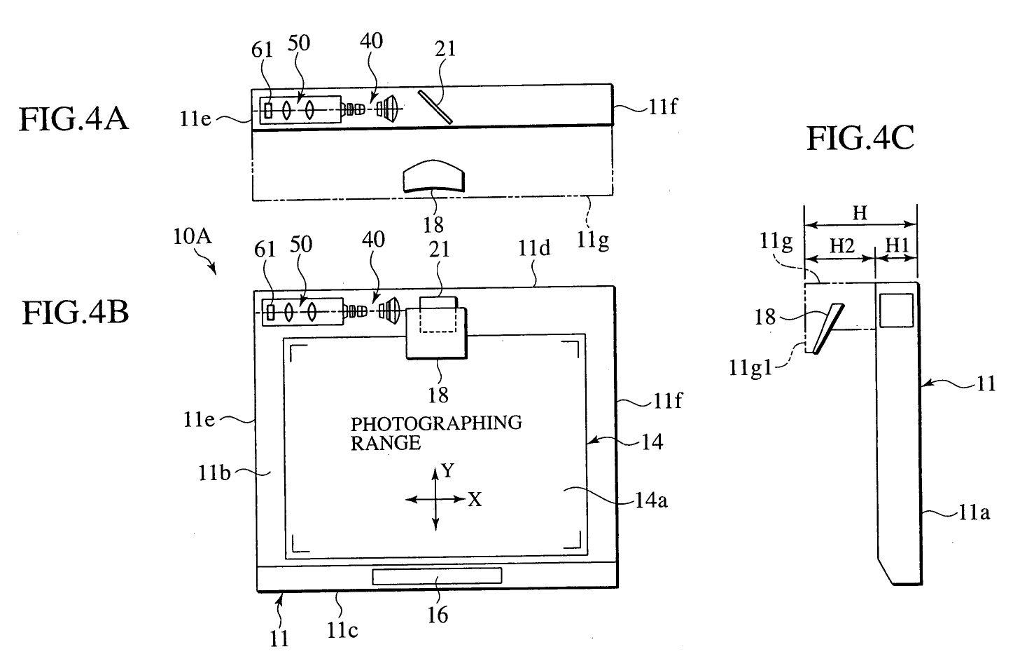

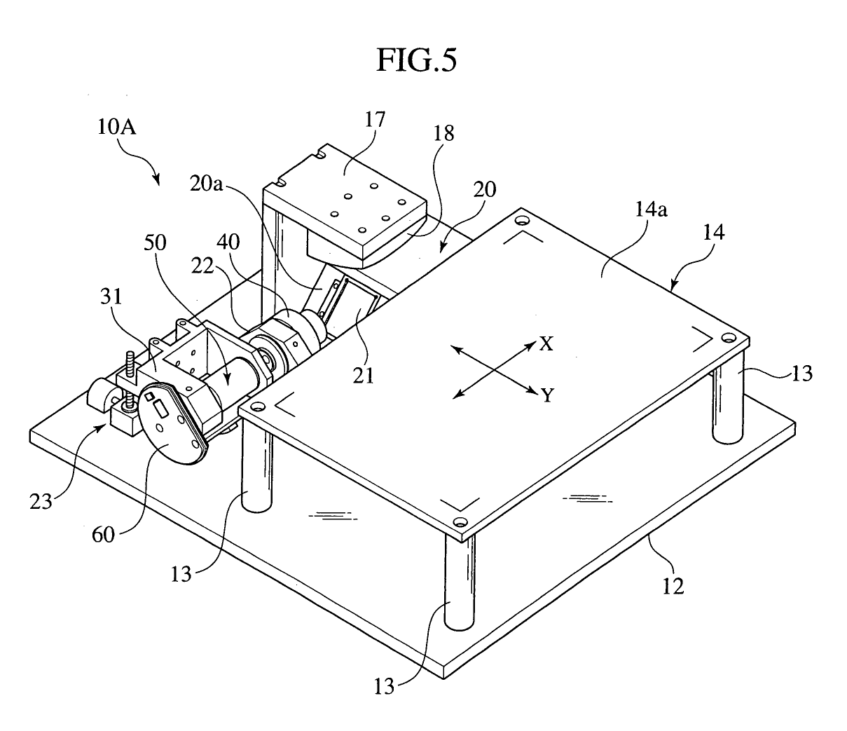

FIG. 3 is a perspective view showing an outer shape of the data presentation apparatus according to the present invention. FIGS. 4A to 4C are a rear view, plan view, and right side view showing the data presentation apparatus according to the present invention. FIG. 5 is a perspective view showing an inner structure from which a housing is removed in the data presentation apparatus according to the present invention.

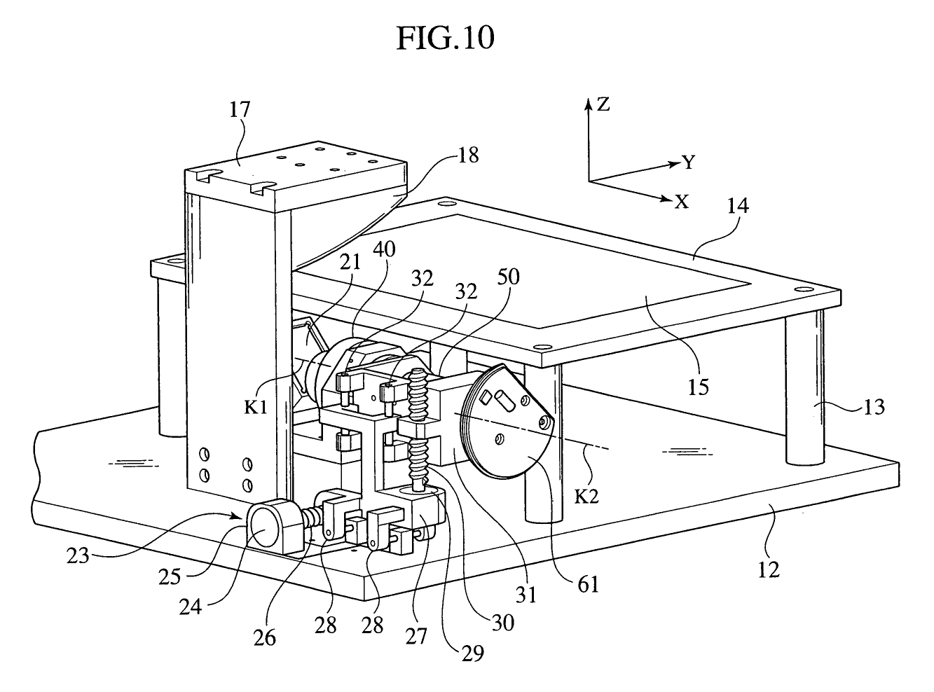

As shown in FIGS. 3, 4A to 4C, and 5, in a data presentation apparatus 10A according to the present invention, a box-shaped housing 11 forms an exterior of the apparatus, and a base 12 which is a table of this apparatus 10A is attached onto a bottom surface 11a in the housing 11. A data laying table 14 is attached substantially in parallel to a base 12 via four supports 13 (shown in FIGS. 5, 10) formed at a predetermined height on the base 12. For the data laying table 14, a flat upper surface 14a whose height agrees with that of an upper surface 11b of the housing 11 is exposed, and data 15 such as a written/drawn draft and solid material can be laid on the upper surface 14a. In this embodiment, for a size of the data laying table 14, the data 15, for example, the written/drawn draft having an A4 size (length×breadth=297 mm×210 mm) can be laid. A longitudinal direction of the data (hereinafter referred to as the written/drawn draft) 15 is directed in an X-axis direction on the data laying table 14 (left/right direction), and a short direction is directed in a Y-axis direction (depth direction). A frame position is displayed as shown in FIGS. 4B and 5 so that the draft can horizontally be laid, and the inside of a frame having the A4 size is set to a photographing range.

Moreover, on a front surface 11c of the housing 11, an operation panel 16 to which a plurality of operation buttons (not shown) are attached is disposed for a user to operate this apparatus 10A. It is to be noted that it is possible to attach the operation panel 16 to a space on the left or right side of the data laying table 14 on the upper surface 11b of the housing 11.

Furthermore, an arcuate support arm 11g is integrally extended upwards from the upper surface 11b between a left-side surface 11e and right-side surface 11f on a rear surface 11d side of the housing 11. Moreover, an aspheric reflection mirror 18 is attached to a portion above an inverted L-shaped stage 17 disposed on the base 12, and this aspheric reflection mirror 18 is disposed opposite to the upper surface 11b of the housing 11 on a middle back-surface side in the left/right direction of the arcuate support arm 11g.

The aspheric reflection mirror 18 constitutes a part of a main part of the present invention. This aspheric reflection mirror 18 is disposed above a longitudinal direction middle portion of the data laying table 14 and above the vicinity of a rear portion of the data laying table 14. Accordingly, the aspheric reflection mirror 18 hardly blocks the portion above the data laying table 14, the written/drawn draft 15 can therefore easily be laid on the data laying table 14, and user's vision is not blocked. It is to be noted that the aspheric reflection mirror 18 can also be disposed above the vicinity of the left-side portion of the data laying table 14 or in the portion above the vicinity of the right-side portion.

Moreover, in the arcuate support arm 11g of the housing 11, a pair of light sources for lighting 19, 19 formed of LED arrays are disposed on opposite sides via the aspheric reflection mirror 18, and directed toward the front of the data laying table 14. In this case, in the pair of light sources for lighting 19, 19, a large number of light emitting elements (LEDs) are arranged in line. Each condenser lens disposed in each LED brightly illuminates the written/drawn draft 15 laid on the data laying table 14.

Furthermore, a height H1 to the upper surface 11b from the bottom surface 11a of the housing 11 is set to around 40 mm, and a height H2 to a top surface 11g1 of the arcuate support arm 11g from the upper surface 11b is set to around 70 mm. Therefore, a whole height H (=H1+H2) of the apparatus 10A is reduced to around 110 mm, and the apparatus 10A is miniaturized.

Additionally, a through hole 11b1 is formed substantially in a rectangular shape in a portion disposed opposite to the aspheric reflection mirror 18 disposed on the rear surface lid side of the housing 11 in the upper surface 11b of the housing 11. Moreover, the through hole 11b1 formed in the upper surface 11b of the housing 11 is a hole for forming a light path. An image light of the written/drawn draft (data) 15 laid on the data laying table 14 is obliquely taken into the aspheric reflection mirror 18. Thereafter, the image light of the written/drawn draft 15 reflected by the aspheric reflection mirror 18 is guided into a plane reflection mirror 21, image forming optical system 40, variable-power optical system 50, and image pickup element 61, which are disposed below the data laying table 14 in the housing 11, in order from the data laying table 14 via the hole as described later.

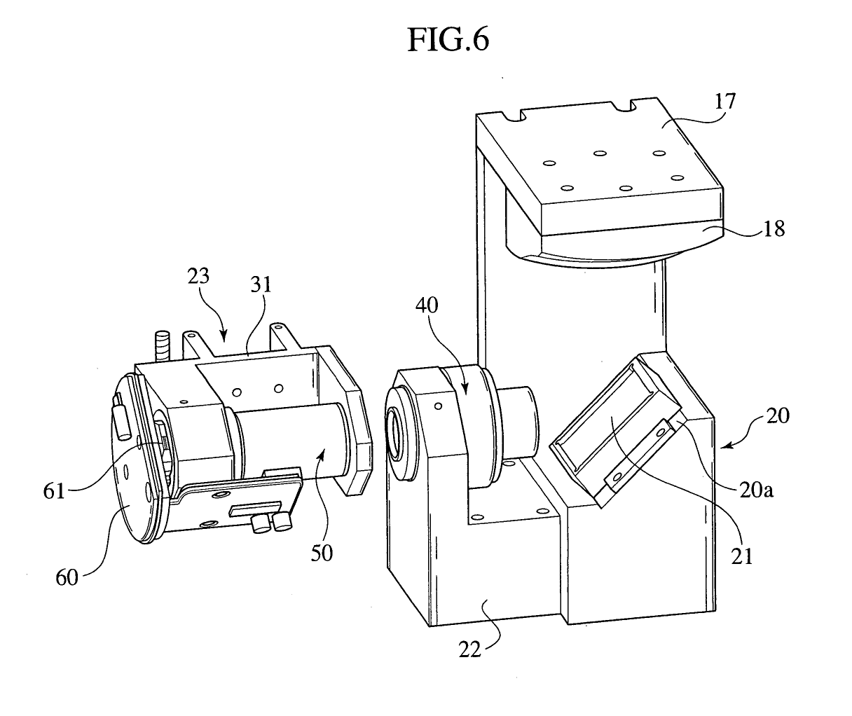

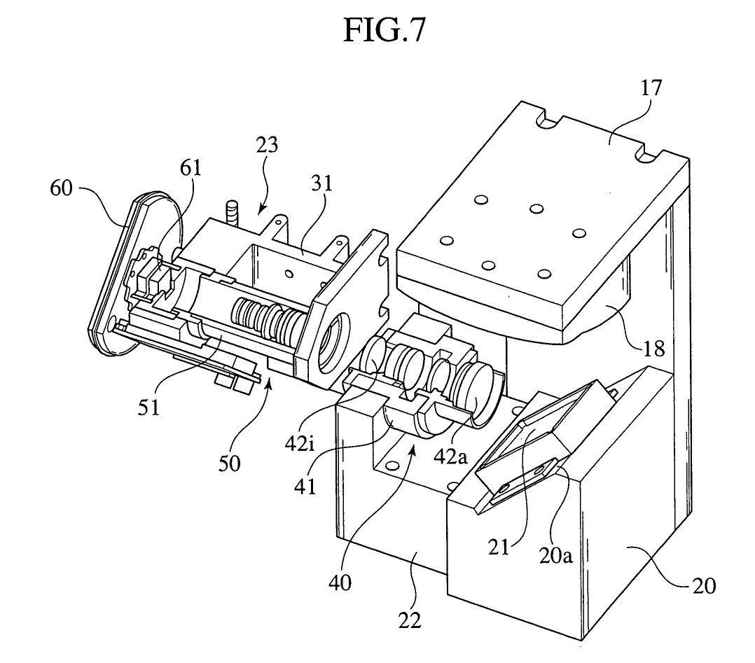

FIG. 6 is a perspective view showing the aspheric reflection mirror, plane reflection mirror, image forming optical system, variable-power optical system, and image pickup element in the data presentation apparatus according to the present invention. FIG. 7 is a partly cut perspective view showing the aspheric reflection mirror, plane reflection mirror, image forming optical system, variable-power optical system, and image pickup element in the data presentation apparatus according to the present invention.

As shown in FIGS. 5 to 7, the plane reflection mirror 21 is attached to a 45° slant surface 20a of a slant stage 20 fixed onto the base 12 while inclined by 45° with respect to the base 12 and data laying table 14. Additionally, the plane reflection mirror 21 is disposed opposite to the aspheric reflection mirror 18 disposed above the mirror. Moreover, the plane reflection mirror 21 changes the direction of the light path of the image light of the written/drawn draft 15 reflected by the aspheric reflection mirror 18 to a direction substantially parallel to the base 12 and data laying table 14, and guides the path into the image forming optical system 40 described later.

In this case, when the image forming optical system 40 is attached substantially horizontally (substantially parallel) with respect to the base 12 and data laying table 14 between the base 12 and data laying table 14, the whole height H of the apparatus 10A can be reduced.

It is to be noted that when the image forming optical system 40 is supported substantially vertically to the base 12 and data laying table 14 as described later, the whole height H of the apparatus 10A increases. In this case, however, without disposing the plane reflection mirror 21, the image light of the written/drawn draft 15 reflected by the aspheric reflection mirror 18 can directly be guided to the image forming optical system 40.

Next, the image forming optical system 40 constituting one portion of the main part of the present invention is attached to an L-shaped stage 22 fixed onto the base 12 substantially in parallel with the base 12 and data laying table 14. The image forming optical system 40 is further disposed opposite to the plane reflection mirror 21 disposed before the system.

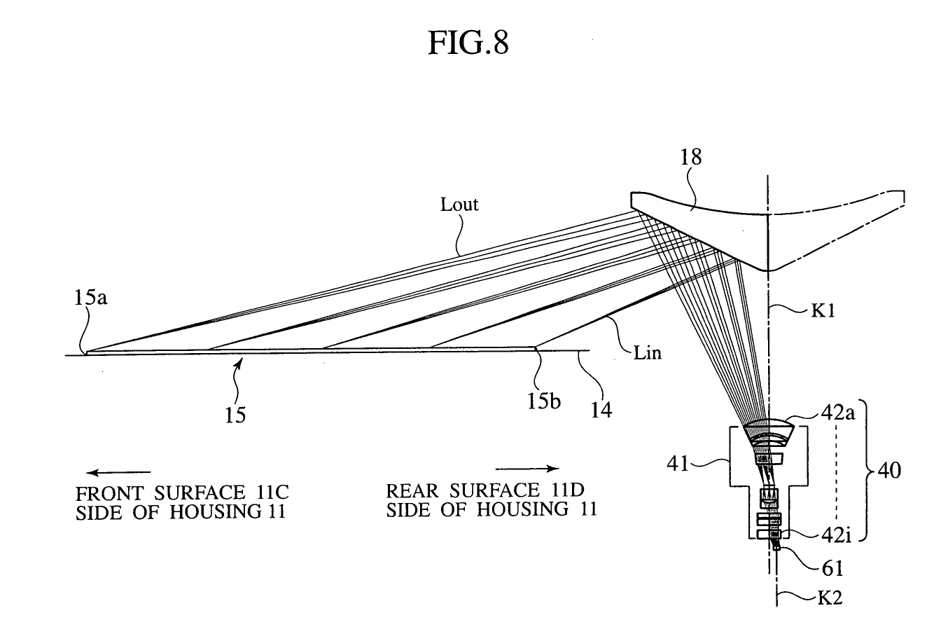

FIG. 8 is a diagram schematically showing an operation of obliquely taking the image light of the written/drawn draft into the aspheric reflection mirror to reflect the light on an image forming optical system side in the data presentation apparatus according to the present invention.

In the image forming optical system 40, as shown in FIGS. 7 and 8, for example, nine lenses 42a to 42i having different shapes are disposed in predetermined positions in a lens body tube 41. Three planes among 18 planes in total by the respective planes of the nine lenses 42a to 42i are formed to be aspheric. It is to be noted that FIG. 8 excludes the plane reflection mirror 21 for changing the light-path direction for the convenience of the description, and shows that the image light of the written/drawn draft 15 reflected by the aspheric reflection mirror 18 is incident directly upon the image forming optical system 40.

That is, in FIG. 8, the aspheric reflection mirror 18 is disposed above the vicinity of the rear part of the data laying table 14. For the aspheric reflection mirror 18, a part of an aspheric lens formed over a range of 360° centering on a light axis K1 substantially vertical to the base 12 and data laying table 14 is cut out as shown by a solid line, and a reflective coat is formed on the surface below the cut-out portion. The light axis of the image forming optical system 40 disposed opposite to the aspheric reflection mirror 18 is matched with the light axis K1 of the aspheric reflection mirror 18. Furthermore, the light axis K2 of the image pickup element 61 is displaced slightly from the light axis K1 of the aspheric reflection mirror 18 and image forming optical system 40, and disposed on the rear surface lid side of the housing 11.

Here, in the state shown in FIG. 8, the image light of the written/drawn draft 15 laid on the data laying table 14 is taken into the image pickup element 61 via the aspheric reflection mirror 18 and image forming optical system 40. In this case, an outermost image light Lout emanating from a front end 15a of the written/drawn draft 15 positioned on the front surface 11c side of the housing 11 is obliquely incident toward the tip-end portion of the aspheric reflection mirror 18 disposed above on the right side in the drawing. The light is also reflected by the aspheric reflection mirror 18, and is obliquely incident upon the image forming optical system 40. A light path length along which the outermost image light Lout passes through the aspheric reflection mirror 18 and image forming optical system 40 in order and reaches the image pickup element 61 is longest.

On the other hand, an innermost image light Lin emanating from a rear end 15b of the written/drawn draft 15 positioned on the rear surface 11d side of the housing 11 is obliquely incident toward the rear-end portion of the aspheric reflection mirror 18, also reflected by the aspheric reflection mirror 18, and obliquely incident upon the image forming optical system 40. The light path length along which the innermost image light Lin passes through the aspheric reflection mirror 18 and image forming optical system 40 in order and reaches the image pickup element 61 is shortest.

Of course, each light path length along which each image light between the outermost image light Lout and innermost image light Lin passes through the aspheric reflection mirror 18 and image forming optical system 40 in order and reaches the image pickup element 61 gradually becomes shorter toward the innermost side from the outermost side.

Therefore, when each light path length of each image light of the written/drawn draft 15 extending to the image pickup element 61 differs, in order to optically and clearly form the image on the image pickup element 61 without any defocus or trapezium distortion, a subject field depth needs to be set to be not less than a difference between the light path lengths of the outermost image light Lout and innermost image light Lin. The aspheric reflection mirror 18 cooperates with three aspheric planes among nine lenses of the image forming optical system 40 to adjust the subject field depth in accordance with each light path length of each image light.

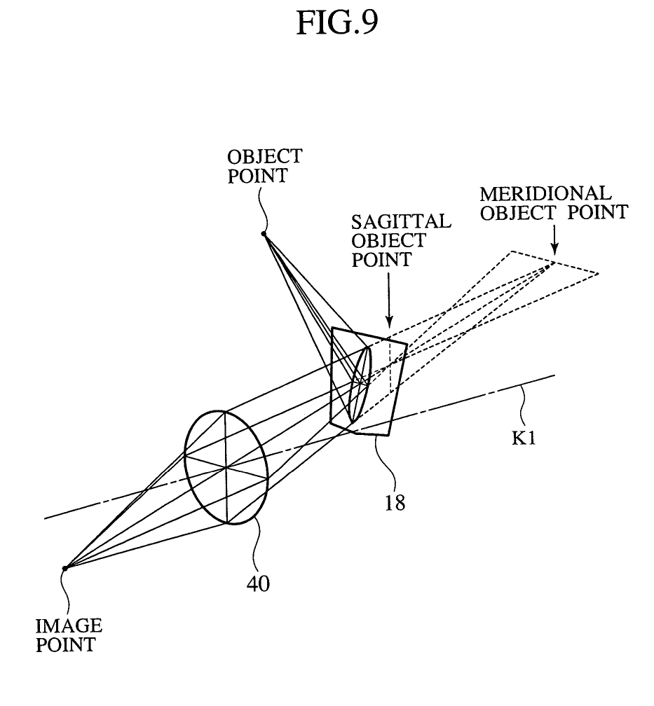

FIG. 9 is an explanatory view schematically showing astigmatism by the aspheric reflection mirror and image forming optical system shown in FIG. 8.

In other words, as shown in FIG. 9, the aspheric reflection mirror 18 and image forming optical system 40 positively uses the astigmatism of the lens. This astigmatism indicates aberrations in which off-axis image points by a light flux emanating from an off-axis object point of the optical system is not concentrated on one point and a sagittal image point and meridional image point appear.

For the image forming optical system 40, to concentrate the sagittal image point and meridional image point of the off-axis image points onto one point, the optical system is constituted having the astigmatism in which the sagittal object point and meridional object point largely deviate in a light-axis direction. Here, the light flux optically taken into the aspheric reflection mirror 18 from the object point is reflected by the aspheric reflection mirror 18 and thereafter formed into the image without any astigmatism in the image forming optical system 40. For this, when the flux is reflected by the aspheric reflection mirror 18, the astigmatism is generated so as to offset the astigmatism of the image forming optical system 40. Therefore, the astigmatism is corrected in the light path extending to the image point from the object point through the aspheric reflection mirror 18 and image forming optical system 40, other aberrations are simultaneously corrected, and a satisfactory formed image is obtained.

FIG. 10 is a perspective view showing the variable-power optical system in the data presentation apparatus according to the present invention.

As shown in FIG. 10, in a biaxial moving type stage 23 disposed on the base 12, the variable-power optical system 50 constituting one portion of the main part of the present invention is disposed so as to be movable in a plane crossing at right angles to the light axis K1 of the image forming optical system 40 disposed before the variable-power optical system.

That is, when the biaxial moving type stage 23 is seen from a rear-surface side of the base 12, in the biaxial moving type stage 23 a first motor 24 is attached onto the base 12 via a bracket 25 toward a Y-axis direction. Moreover, a first worm 26 fixed to the shaft of the first motor 24 meshes with a Y-axis stage 27, and the Y-axis stage 27 is guided by a pair of Y-axis direction guide means 28, 28. Therefore, when the first motor 24 is driven, the Y-axis stage 27 can move in the Y-axis direction (front/rear direction).

Moreover, for the biaxial moving type stage 23, a second motor 29 is attached onto the Y-axis stage 27 toward a Z-axis direction. Furthermore, a second worm 30 fixed to the shaft of the second motor 29 meshes with a Z-axis stage 31, and the Z-axis stage 31 is guided by one pair of Z-axis direction guide means 32, 32. Therefore, when the second motor 29 is driven, the Z-axis stage 31 can move in the Z-axis direction (vertical direction).

It is to be noted that it is also possible to use a known laminated piezoelectric element (not shown) as a driving source for displacing the Y-axis stage 27 and Z-axis stage 31 in the Y-axis and Z-axis directions without using the first and second motors 24, 29.

Moreover, when the variable-power optical system 50 is attached to the Z-axis stage 31 formed substantially in a U shape, the variable-power optical system 50 can move in the Y-axis and Z-axis directions. In other words, since the variable-power optical system 50 can move in the plane crossing at right angles to the light axis K1 of the image forming optical system 40, the light axis K2 of the variable-power optical system 50 also moves substantially in parallel with the light axis K1 of the image forming optical system 40 in the plane crossing at right angles to the light axis K1.

Accordingly, the image light of the written/drawn draft 15 laid on the data laying table 14 is obliquely taken into the aspheric reflection mirror 18. The image light of the written/drawn draft 15 reflected here is obliquely incident upon the image forming optical system 40 via the plane reflection mirror 21, and an intermediate image MG (FIG. 12) is optically clearly formed by the image forming optical system 40 without any defocus or trapezium distortion At this time, the variable-power optical system 50 moves substantially in parallel with the intermediate image MG, and the desired range in the intermediate image MG is optically varied at a desired magnification to form the image again. The optically power-varied image light of the data is received by the image pickup element 61 attached to a lens body tube 51 via an image pickup element support member 60 as shown in FIG. 7.

It is to be noted that as described later the image light of the written/drawn draft 15 laid on the data laying table 14 is obliquely taken into the aspheric reflection mirror 18, and the image light of the written/drawn draft 15 reflected here may be directly obliquely incident upon the image forming optical system 40 to form the intermediate image MG by the image forming optical system 40. At this time, when the variable-power optical system 50 is moved in the X-axis and Y-axis directions substantially parallel to the data laying table 14, the variable-power optical system 50 can move in the plane crossing at right angles to the light axis KI of the image forming optical system 40.

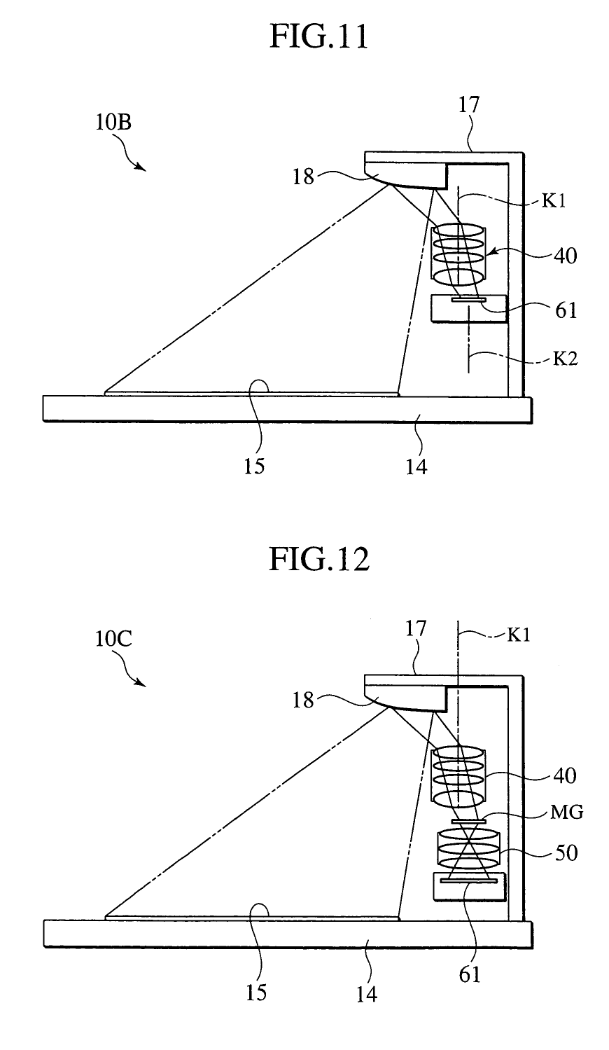

Next, as described above, in the data presentation apparatus 10A according to the present invention, to set the whole height H of the apparatus 10A to be low, the light path of the image light of the written/drawn draft 15 reflected by the aspheric reflection mirror 18 is changed by the plane reflection mirror 21, and the light is guided into the image forming optical system 40 disposed substantially horizontally in the housing 11. This case has been described. However, the image light of the written/drawn draft 15 reflected by the aspheric reflection mirror 18 may directly be guided into the image forming optical system 40. Several modification examples of this case will be described with reference to FIGS. 11 to 16.

FIG. 11 is a diagram schematically showing that the image light of the written/drawn draft reflected by the aspheric reflection mirror is directly guided into the image forming optical system in the data presentation apparatus of a first modification example according to the present invention.

As shown in FIG. 11, in a data presentation apparatus 10B of the first modification example according to the present invention, in the same manner as in the data presentation apparatus 10A according to the present invention, the aspheric reflection mirror 18 is disposed above the vicinity of the rear part of the data laying table 14 via the inverted L-shaped stage 17.

In this first modification example, the image light of the written/drawn draft 15 laid on the data laying table 14 is obliquely taken into the aspheric reflection mirror 18, and the image light of the written/drawn draft 15 reflected here is obliquely incident directly upon the image forming optical system 40. The image light of the written/drawn draft 15 optically clearly formed into the image by the image forming optical system 40 without any defocus or trapezium distortion is received by the data image pickup element 61. In this case, the light axis K2 of the image pickup element 61 is displaced on the rear side of the data laying table 14 with respect to the light axis K1 of the image forming optical system 40.

FIG. 12 is a diagram schematically showing that the variable-power optical system is disposed between the image forming optical system and image pickup element in the data presentation apparatus of a second modification example according to the present invention.

As shown in FIG. 12, even with a data presentation apparatus 10C of the second modification example of the present invention, the aspheric reflection mirror 18 is disposed above the vicinity of the rear part of the data laying table 14 via the inverted L-shaped stage 17. Additionally, the variable-power optical system 50 is disposed between the image forming optical system 40 and image pickup element 61 so as to be movable in the plane crossing at right angles to the light axis K1 of the image forming optical system 40.

In this second modification example, the image light of the written/drawn draft 15 laid on the data laying table 14 is obliquely taken into the aspheric reflection mirror 18, the image light of the written/drawn draft 15 reflected here is obliquely incident directly upon the image forming optical system 40, and the intermediate image MG is formed by the image forming optical system 40. Thereafter, with respect to the intermediate image MG formed by the image forming optical system 40, the variable-power optical system 50 is appropriately moved in the plane crossing at right angles to the light axis K1 of the image forming optical system 40. The intermediate image MG is optically and clearly formed again at the desired magnification by the variable-power optical system 50, and the image light optically power-varied by the variable-power optical system 50 is received by the image pickup element 61. In this case, the lens constitution of the variable-power optical system 50 is optically power-variable over the tele-side in enlarging and photographing a part of the written/drawn draft 15 from the wide side in entirely photographing the written/drawn draft 15.

Additionally, another method is possible comprising: disposing electronic zoom processing means for electronically varying the magnification of the image light of the written/drawn draft 15 formed on the image pickup element 61 by the image forming optical system 40 without disposing the variable-power optical system 50 between the image forming optical system 40 and image pickup element 61. The method by the electronic zoom processing means comprises: setting a cut-out frame on the image pickup element 61 with respect to the image light of the written/drawn draft 15 formed into the image on the image pickup element 61; and electronically varying the magnification in the cut-out frame to the desired magnification.

It is further possible to dispose the variable-power optical system 50 between the image forming optical system 40 and image pickup element 61, to dispose the electronic zoom processing means, and to use both the variable-power optical system 50 and electronic zoom processing means.

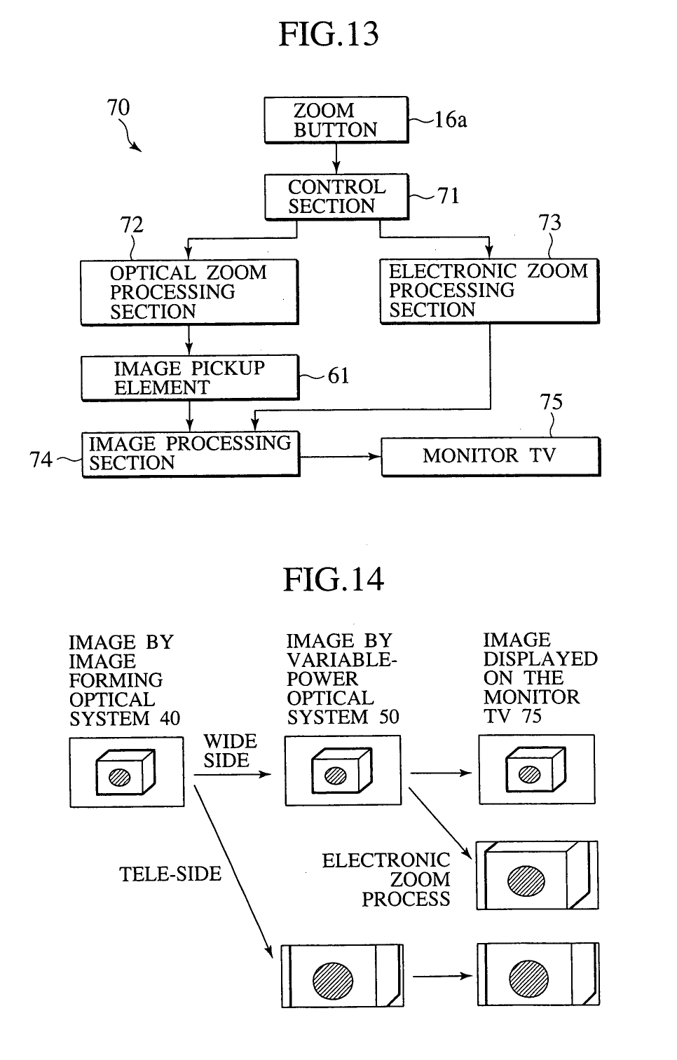

FIG. 13 is a block diagram showing an optical zoom process for optically varying the magnification of the image of the data formed by the image forming optical system and an electronic zoom process for electronically varying the magnification in the data presentation apparatus of the second modification example of the present invention in which the variable-power optical system is disposed between the image forming optical system and image pickup element.

For variable-power processing means 70 shown in FIG. 13, a user selects a magnification to be varied with a zoom button 16a disposed in the operation panel 16 (FIGS. 3, 4), and informs a control section 71 of this. Thereafter, the control section 71 instructs whether to operate an optical zoom processing section 72 or an electronic zoom processing section 73 in accordance with the varied magnification selected with the zoom button 16a.

FIG. 14 is a schematic diagram showing an optical zoom process for switching the image of the data formed by the image forming optical system on a wide side and tele-side to optically vary the magnification, and an electronic zoom process for electronically varying the magnification of the image of the data formed by the image forming optical system between the wide side and tele-side in the data presentation apparatus of the second modification example according to the present invention.

In the optical zoom processing section 72, as shown in FIG. 14, the lens constitution is simplified so that the magnification can optically be varied with respect to only two focal distances on the wide side and tele-side in the variable-power optical system 50. The magnification is electronically varied by the electronic zoom processing section 73 between the wide side and tele-side.

Moreover, the zoom button 16a is operated to switch the variable-power optical system 50 on the wide side or tele-side, and the control section 71 operates the optical zoom processing section 72. At this time, the image light of the data on the wide side, or the image light of the data on the tele-side again formed into the image by the variable-power optical system 50 is received by the image pickup element 61. The image light of the data received here is appropriately processed by an image processing section 74, and displayed in a monitor TV 75.

On the other hand, when the control section 71 operates the electronic zoom processing section 73, the variable-power optical system 50 is set on the wide side beforehand, and the image light of the written/drawn draft 15 laid on the data laying table 14 is entirely formed into the image again by the variable-power optical system 50 in a wide state. The light is received by the image pickup element 61, and an output of the image pickup element 61 is inputted into the image processing section 74. Moreover, the image processing section 74 sets the cut-out frame on the image pickup element 61 into the image light of the data by the varied magnification from the optical zoom processing section 72. The magnification in the cut-out frame is electronically varied between the wide side and tele-side in accordance with the varied magnification, and the image is displayed in the monitor TV 75.

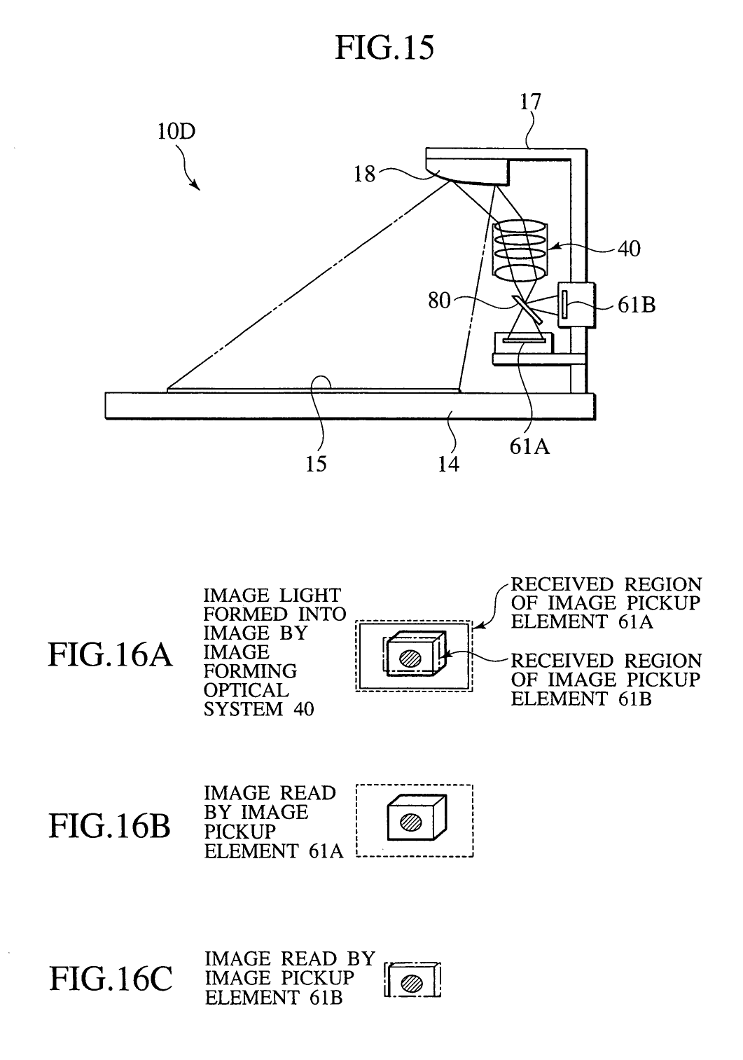

FIG. 15 is a diagram schematically showing that light path branch means for branching a light path toward two image pickup elements is disposed after the image forming optical system in the data presentation apparatus of a third modification example according to the present invention. FIGS. 16A to 16C are diagrams showing the images whose lights are received by two image pickup elements having different sizes of light receiving regions, when the light path is branched by the light path branch means shown in FIG. 15 in the data presentation apparatus of the third modification example according to the present invention.

As shown in FIG. 15, in a data presentation apparatus 10D of the third modification example of the present invention, the aspheric reflection mirror 18 is disposed above the vicinity of the rear part of the data laying table 14 via the inverted L-shaped stage 17. Additionally, after the image forming optical system 40, a semi-transmission reflection mirror 80 is disposed as the light path branch means for branching the light path toward two image pickup elements 61A, 61B including the light receiving regions having different sizes.

In this third modification example, the light path of the image light of the written/drawn draft 15 formed into the image by the image forming optical system 40 is divided into two by the semi-transmission reflection mirror 80. That is, the image light of the written/drawn draft 15 formed into the image by the image forming optical system 40 passes through the semi-transmission reflection mirror 80, and is read by the image pickup element 61A disposed in one light path as shown in FIGS. 16A and 16B. The image light of the written/drawn draft 15 is further reflected by the semi-transmission reflection mirror 80, and read by the image pickup element 61B disposed in the other light path as shown in FIGS. 16A and 16C.

In this case, the image of the written/drawn draft 15 whose light is received by the image pickup element 61A including the light receiving region having a large area may be displayed as such in the monitor TV 75 (FIG. 13) via the image processing section 74 (FIG. 13). Alternatively, the electronic zoom processing section 73 (FIG. 13) may cooperate with the image processing section 74 to electronically vary the magnification, and the image is displayed in the monitor TV 75. On the other hand, the image of the written/drawn draft 15 whose light is received by the image pickup element 61B including the light receiving region having a small area is displayed as such in the monitor TV 75 via the image processing section 74.

It is to be noted that the semi-transmission reflection mirror 80 has been described as the light path branch means, but the present invention is not limited to this mirror, and a prism (not shown) on which a semi-transmission reflective coat is formed may also be used. Moreover, when a plurality of semi-transmission reflection mirrors 80 are disposed after the image forming optical system 40, the image light of the written/drawn draft 15 formed into the image by the image forming optical system 40 can be received by a plurality of image pickup elements including the light receiving regions having different sizes. Furthermore, it is also possible to dispose the light path branch means (80) after the variable-power optical system 50.

It should be understood that many modifications and adaptations of the invention will become apparent to those skilled in the art and it is intended to encompass such obvious modifications and changes in the scope of the claims appended hereto.

What is claimed is:

1. A data presentation apparatus comprising:
a data laying table on which data such as a written/drawn draft and solid material are to be laid;
an aspheric reflection mirror, disposed above the vicinity of a side part of the data laying table, for obliquely taking an image light of the data laid on the data laying table and reflecting the image light of the data;
an image forming optical system which cooperates with the aspheric reflection mirror to form the image light of the data reflected by the aspheric reflection mirror into an image; and
an image pickup element for receiving the image light of the data formed into the image by the image forming optical system.

2. The data presentation apparatus according to claim 1, further comprising:
a variable-power optical system which optically varies magnification of the image light of the data formed into the image by the image forming optical system and which is disposed between the image forming optical system and the image pickup element.

3. The data presentation apparatus according to claim 2, wherein the variable-power optical system is disposed so as to be movable in a plane crossing at right angles to a light axis of the image forming optical system.

4. The data presentation apparatus according to claim 1, further comprising:
an electronic zoom processing device for electronically varying the magnification of the image light of the data formed into the image by the image forming optical system.

5. The data presentation apparatus according to claim 1, further comprising:
a variable-power optical system which switches the image light of the data formed into the image by the image forming optical system to a wide side or tele-side to optically vary the magnification and which is disposed between the image forming optical system and the image pickup element; and
an electronic zoom processing device for electronically varying the magnification of the image light of the data formed into the image by the image forming optical system between the wide side and the tele-side.

6. The data presentation apparatus according to claim 2, further comprising:
a plurality of image pickup elements including light receiving regions having different sizes; and
a light path branch device, disposed after the image forming optical system or after the variable-power optical system, for branching a light path toward the plurality of image pickup elements.
